(19) United States
(12) Patent Application Publication
(10) Pub. No.: US 2025/0208804 A1
(43) Pub. Date: Jun. 26, 2025

(54) PRINTING SYSTEM, PRINTING METHOD, AND NON-TRANSITORY COMPUTER-READABLE RECORDING MEDIUM STORING PRINTING PROGRAM

(71) Applicant: KONICA MINOLTA, INC., Tokyo (JP)

(72) Inventor: Kouyo SUZUKI, Tokyo (JP)

(73) Assignee: KONICA MINOLTA, INC., Tokyo (JP)

(21) Appl. No.: 18/954,974

(22) Filed: Nov. 21, 2024

(30) Foreign Application Priority Data
Dec. 21, 2023 (JP) 2023-216214

(51) Int. Cl. G06F 3/12; G06T 7/90

(52) U.S. Cl. CPC G06F 3/1244; G06F 3/1208; G06T 7/90; G06F 3/1297; G06T 2207/10024

(57) ABSTRACT

A printing system comprising a hardware processor, in which, when a print job has been executed, the hardware processor stores, in a storage 23, an adjusted color conversion table adjusted by a user used in the print job, and type information of an object shown in an image to be printed that has been identified by image analysis in association with each other, and, when executing a new print job, the hardware processor generates a screen for setting a color conversion table to be used in the new print job, and displays, in the screen, identification information of each of a plurality of the adjusted color conversion tables stored in the storage 23 together with the type information of the object in a selectable manner as a list of color conversion table use history.

### CROSS REFERENCE TO RELATED APPLICATIONS

The entire disclosure of Japanese Patent Application No. 2023-216214 filed on Dec. 21, 2023 is incorporated herein by reference in its entirety.

### BACKGROUND

### Technological Field

The present disclosure relates to a printing system, a printing method, and a non-transitory computer-readable recording medium storing a printing program.

### Description of Related Art

Conventionally, a technique is known that performs color conversion processing on an input image and perform printing of the image after the color conversion processing.

For example, Japanese Unexamined Patent Publication No. 2013-219587 discloses that a person image is cut out from a captured image, the person image is subjected to color conversion processing so that the person image has brightness suitable for an identification photograph, the person image is combined with a background image, and the combined image is printed.

Further, Japanese Unexamined Patent Publication No. 2003-111007 discloses that an original image is printed after image processing is performed so that the image quality at a designated position of the original image is close to a predetermined target value.

In general, in the field of professional printing, color conversion for reproducing the color of an image serving as a document in accordance with a target color sample is performed by a “color conversion table (also referred to as an ICC profile)” using a technique called color management.

In some cases, however, there is no target color sample or the like at the site of actual printing and a printed product must be printed with colors adjusted to “preferable colors” that are accepted by the client for each printing. In such a case, a skilled person performs test printing while correcting the color conversion table, and adjusts the color conversion table by visual inspection.

FIG. 1 is a diagram illustrating an example of color adjustment of an image using a color conversion table. In FIG. 1, the left diagram illustrates an original image before color adjustment, and the right diagram illustrates an image after color adjustment. Here, a photograph of meat used in a leaflet of a supermarket is used.

Generally, in a leaflet of a supermarket, in order to make meat look delicious, blue and yellow are suppressed, and red and white are emphasized. In this case, for example, the user adjusts the profile of the input/output curve of the color conversion table to control the color and brightness or to emphasize white.

However, the color conversion table adjusted in this way is not necessarily suitable for another printed matter. For example, a color conversion table adjusted for a leaflet of a supermarket cannot be used for a leaflet of a household appliance. This is because, in a leaflet of home appliances, it is important that the details of the home appliances can be visually recognized, and if a color conversion table in which white is emphasized is used, the details of the white home appliances are lost.

Such adjustment of the color conversion table is difficult except for a skilled person, and further the adjustment work is complicated. Under such circumstances, there is a demand for reducing the setting work of the color conversion table at the time of printing new received data by reusing the adjusted color conversion table used in the past.

In order to meet such a demand, some recent printing systems adopt a technique of displaying a list of use histories of color conversion tables used in the past on a screen for setting a color conversion table to be used in a new print job. However, at present, it is hard to say that a user can easily select a color conversion table suitable for use in a new print job from a list of use histories of color conversion tables (see, for example, Japanese Unexamined Patent Publication No. 2007-181251).

### SUMMARY

The present disclosure has been made in view of the above-described problems, and an object of the present disclosure is to provide a printing system, a printing method, and a non-transitory computer-readable recording medium storing a printing program, which are more preferable and capable of reducing the setting work of the color conversion table.

### Means for Solving the Problem

For solving the above-described problems, a printing system according to the present disclosure includes a hardware processor, in which, when a print job has been executed, the hardware processor stores, in a storage, an adjusted color conversion table adjusted by a user used in the print job, and type information of an object shown in an image to be printed that has been identified by image analysis in association with each other, and in which, when executing a new print job, the hardware processor generates a screen for setting a color conversion table to be used in the new print job, and displays, in the screen, identification information of each of a plurality of the adjusted color conversion tables stored in the storage together with the type information of the object in a selectable manner as a list of color conversion table use history.

A printing method according to another aspect includes: when a print job has been executed, storing, in a storage, an adjusted color conversion table adjusted by a user used in the print job, and type information of an object shown in an image to be printed that has been identified by image analysis in association with each other, and when executing a new print job, generating a screen for setting a color conversion table to be used in the new print job, and displaying, in the screen, identification information of each of a plurality of the adjusted color conversion tables stored in the storage together with the type information of the object in a selectable manner as a list of color conversion table use history.

A non-transitory computer-readable recording medium according to another aspect is a medium storing a printing program for causing a computer to execute: when a print job has been executed, a process of storing, in a storage, an adjusted color conversion table adjusted by a user used in the print job, and type information of an object shown in an image to be printed that has been identified by image analysis in association with each other, and when executing a new print job, a process of generating a screen for setting a color conversion table to be used in the new print job, and displaying, in the screen, identification information of each of a plurality of the adjusted color conversion tables stored in the storage together with the type information of the object in a selectable manner as a list of color conversion table use history.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of color adjustment of an image using a color conversion table;

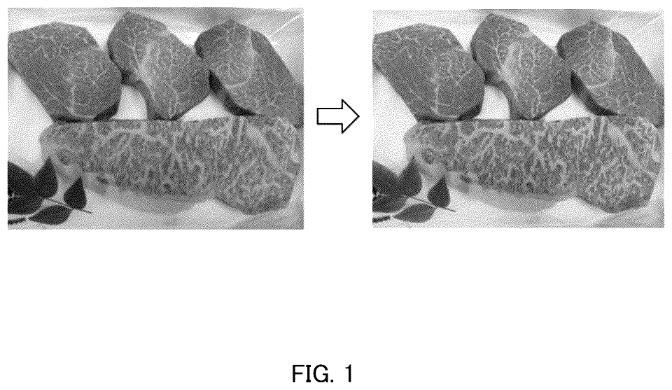

FIG. 2 is a diagram illustrating an example of a system configuration of a printing system;

FIG. 3 is a diagram illustrating an example of a hardware configuration of a controller member;

FIG. 4 is a diagram illustrating an example of a functional configuration of a CPU;

FIG. 5 is a diagram illustrating an example of a color conversion table setting screen displayed on the display under the control of the color conversion table setter;

FIG. 6 is a diagram illustrating an example of an image to be printed in a past print job;

FIG. 7 is a diagram illustrating an example of an adjusted color conversion table used in a past print job;

FIG. 8 is a diagram illustrating an example of an operation flow of the controller when a print job is executed;

FIG. 9 is a diagram illustrating a modification example of the operation flow of the controller;

FIG. 10 is a diagram illustrating a modification of the color conversion table setting screen;

FIG. 11 is a diagram illustrating another modification of the color conversion table setting screen;

FIG. 12 is a diagram illustrating an example of a setting screen for a point color adjustment function;

FIG. 13 is a diagram illustrating another modification of the color conversion table setting screen;

FIG. 14 is a diagram illustrating another modified example of the color conversion table setting screen; and

FIG. 15 is a diagram illustrating an example of a screen for setting display items in the color conversion table setting screen.

### DETAILED DESCRIPTION OF EMBODIMENTS

Hereinafter, one or more embodiments of the present invention will be described with reference to the drawings. However, the scope of the invention is not limited to the disclosed embodiments.

### Configuration of Printing System 100

First, a configuration of a printing system 100 according to an embodiment of the present invention will be described.

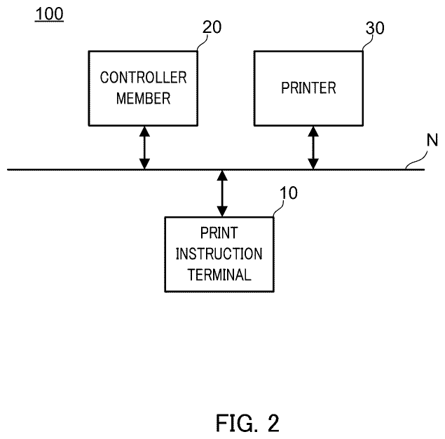

FIG. 2 is a diagram illustrating an example of a system configuration of the printing system 100. As illustrated in FIG. 2, the printing system 100 includes a print instruction terminal 10, a controller member 20, and a printer 30, and the respective devices are connected via a communication network N so as to be capable of data communication. Note that the number of each device is not particularly limited.

The print instruction terminal 10 issues a print instruction to the controller member 20 by using a printer driver program or dedicated software. To be more specific, in response to a user operation, the print instruction terminal 10 generates, as the information on the job, information in a page description language (PDL) that can be interpreted by the controller member 20, and transmits the generated print data to the controller member 20.

The controller member 20 performs rasterization (also referred to as RIP processing) on the print data transmitted from the print instruction terminal 10 to create print image data. Next, the controller member 20 performs image processing, such as color conversion and screening, on the image data for printing and transmits the image data to the printer 30. The controller member 20 may be built in the printer 30. Alternatively, the controller member 20 and the printer 30 may be connected via a dedicated line such as a PCI connection.

The printer 30 is an image forming device that performs printing based on image data (CMYK data) in a bitmap format received from the controller member 20. As a printing method in the printer 30, various printing methods such as an electrophotographic method and an inkjet method can be adopted.

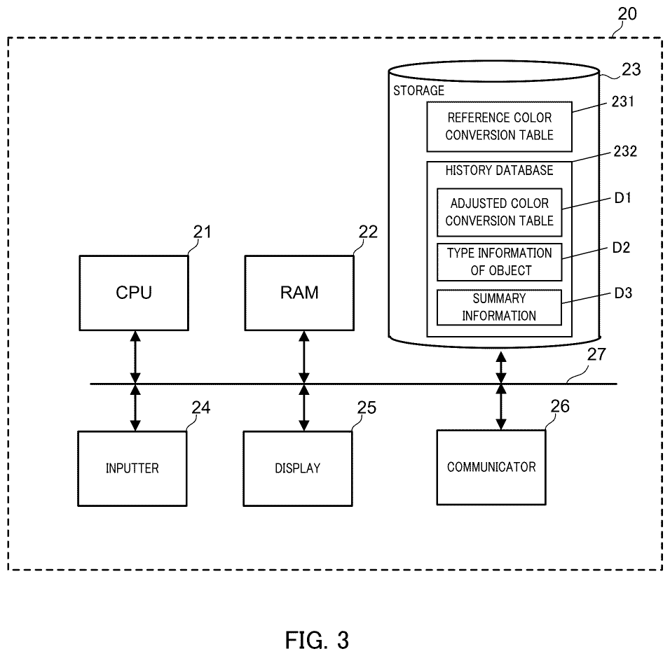

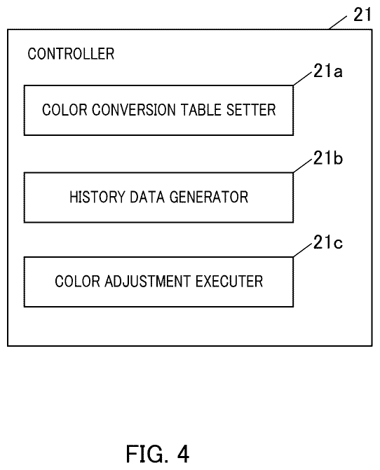

FIG. 3 is a diagram illustrating an example of a hardware configuration of the controller member 20. FIG. 4 is a diagram illustrating an example of a functional configuration of the CPU 21.

The controller member 20 includes a central processing unit (CPU) 21, a random access memory (RAM) 22, a storage 23, an inputter 24, a display 25, a communicator 26, and the like, and these units are connected to each other via a bus 27.

The CPU 21 is a controller (hereinafter, also referred to as a “controller 21”) that integrally controls a processing operation of each unit of the controller member 20. In response to an operation signal or the like input from the inputter 24, the CPU 21 reads out various processing programs and data stored in the storage 23, develops them in the RAM 22, and executes various processes in cooperation with the programs.

To be more specific, the controller 21 functions as a color conversion table setter 21a, a history data generator 21b, and a color adjustment executer 21c by executing various processing programs stored in the storage 23 (see FIG. 4).

In addition, the controller 21 analyzes print data (PDL data) received from the print instruction terminal 10, and develops the print data into print image data (CMYK values) in a bitmap format.

The RAM 22 forms a work area for temporarily storing various processing programs to be executed by the controller 21 and data related to these programs.

The storage 23 includes a storage device such as a nonvolatile semiconductor memory or a hard disk, and stores various processing programs (for example, a RIP processing program and a color adjustment processing program), data relating to various processes, and the like.

The storage 23 according to the present embodiment stores a reference color conversion table 231 and a history database 232.

The reference color conversion table 231 is a color conversion table that is initially set so as to adjust the distortion of the color output of the printer 30 and the like from the viewpoint of color management. The reference color conversion table 231 is read, for example, when a color conversion table to be used in a new print job is set, and is adjusted by the user so as to have a profile suitable for the print job.

The history database 232 is history data related to a color conversion table (hereinafter, referred to as an “adjusted color conversion table”) adjusted by a user so as to be adapted to a print target in a past print job.

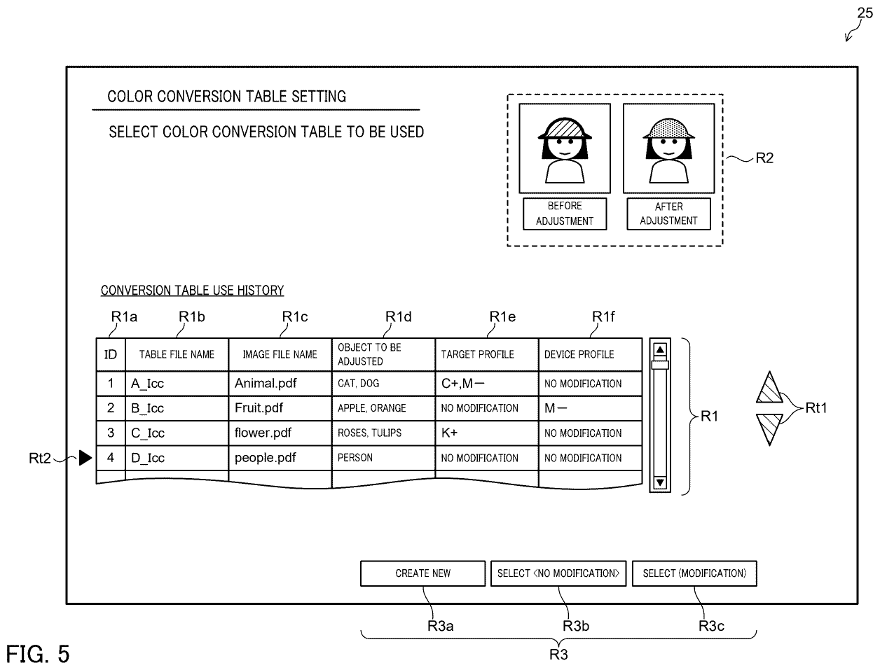

In the history database 232, for example, each time a new adjusted color conversion table D1 is created, the adjusted color conversion table D1 is registered. Then, in the history database 232, the type information D1 of the object in the printed image and the summary information D2 of the adjusted color conversion table D1 are registered in association with the adjusted color conversion table D3. On a color conversion table setting screen which will be described later with reference to FIG. 5, the contents of the history database 232 are displayed as a “list of color conversion table use history”.

Note that the color conversion tables (here, the reference color conversion table 231 and the adjusted color conversion table D1) are composed of, for example, a target profile and a printer profile. In order to perform color conversion processing, a color conversion table of a device which is a target of color matching is required, and the color conversion table is referred to as a target profile. The target profile is a color conversion table that indicates a correspondence between device values and color values for converting device-dependent device values (e.g., CMYK values and RGB values) into device-independent color values (e.g., XYZ values and L*a*b* values). As the target profile, usually, a profile of an offset press or a standard profile such as Japan Color is selected. The printer profile is a color conversion table that indicates a correspondence between a color value and a device value for converting a color value into a device value of the printer 30. That is, the profile of the printer 30 that actually performs output is selected as the printer profile.

That is, the device values (RGB values or the like) of the input image data are converted into device-independent color values by using the target profile, and the color values are converted into device values (CMYK values or the like) of the printer 30 as an output device by using the printer profile. Next, printing by the printer 30 is executed using the image data converted so as to correspond to the device values (CMYK values) of the printer 30 obtained through this conversion.

Note that as the color conversion table to be used, one in which a color conversion table from the device value of the input device to the color value and a color conversion table from the color value to the device value of the output device are made into one LUT may be used. Such an LUT is also referred to as a device link profile.

The adjusted color conversion table D1 is, for example, a color conversion table in which the content of adjustment performed on the reference color conversion table 231 by the user is reflected so that color conversion suitable for the image to be printed is performed. In this embodiment, the adjusted color conversion table D1 is stored separately for the adjusted target profile and the adjusted printer profile.

The adjusted color conversion table D1 may be stored in the form of changes from the reference color conversion table 231, or may be stored in the form of the input/output profile of the adjusted color conversion table D1 itself.

The type information D2 of the object is information on the type of an object shown in an image to be printed to which the adjusted color conversion table D1 has been applied. The type information D2 of the object is registered so that the user can identify the type of an object that is an adjustment target in the adjusted color conversion table D1. In other words, it is registered so that the user can identify the intended use of each adjusted color conversion table D1 on the screen for setting the color conversion table to be used in the current print job. The type information D2 of the object is generated by image analysis (e.g., pattern recognition) of an image to be printed by the controller 21. Note that the data format of the type information D2 of the object may be an object type ID, or may be data of a character string or a symbol string.

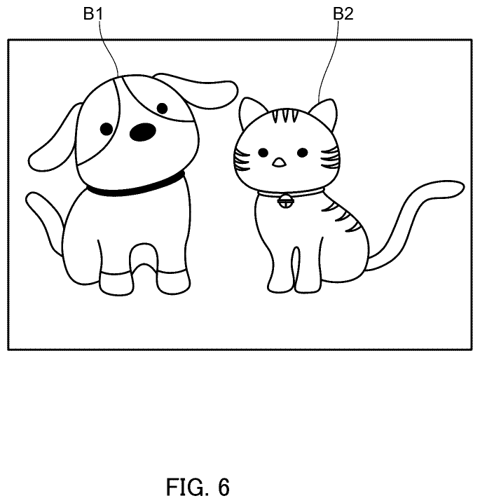

Here, the type information D2 of the object to be registered is, for example, a type of a main object in the image to be printed, and includes, for example, meats of a leaflet of a supermarket, white goods of a leaflet of a home appliance mass retailer, and the like. As illustrated in FIG. 6, when a cat B2 and a dog B1 are included in the image to be printed, for example, “cat, dog” is registered as the type information D2 of the object. However, it is preferable that the type information D2 of the object reflects the use of the printed matter. From this point of view, instead of the units of individuals such as “cat and dog”, units of parts of individuals such as “face of a person” may be registered. The details of the type to be registered can be adjusted by, for example, setting of the pattern recognition processing (i.e., setting of an object to be identified) by the history data generator 21b.

The summary information D3 is information registered to enable a user to identify, at a glance, the content of color adjustment to be applied to an image by the adjusted color conversion table D1 stored in association with the summary information SL. The summary information D3 is registered as, for example, information in which the profile (that is, characteristics) of the input/output curve of the adjusted color conversion table D1 is represented by a character string or a symbol string that can be recognized by the user. The summary information D3 is generated, for example, when a new adjusted color conversion table D1 is registered, by the controller 21 (history data generator 21b) converting the adjusted color conversion table D1.

In addition, the storage 23 stores print data received from the print instruction terminal 10, RIP-processed print image data, user information, and the like.

The inputter 24 includes, for example, a keyboard including a cursor key, a character input key, various function keys, and the like, and a pointing device such as a mouse, and receives an operation input by a user. The inputter 24 outputs, to the CPU 21, an operation signal input by a key operation on the keyboard or a mouse operation.

The display 25 includes, for example, a liquid crystal display (LCD), and displays various operation screens and various processing results in accordance with instructions from the CPU 21.

Note that the inputter 24 and the display 25 according to the present embodiment are integrally configured by a liquid-crystal display with a touch panel.

The communicator 26 transmits and receives data to and from an external device (for example, the print instruction terminal 10 or the printer; 30) via the communication network N.

### Detailed Configuration of Controller 21

Here, functions of the color conversion table setter 21a, the history data generator 21b, and the color adjustment executer 21c of the controller 21 will be described in detail.

FIG. 5 is a diagram illustrating an example of a color conversion table setting screen displayed on the display 25 under the control of the color conversion table setter 21a.

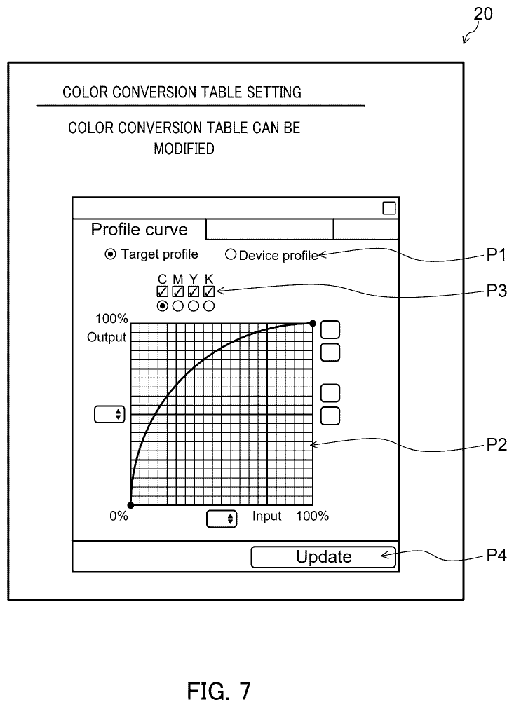

FIG. 6 is a diagram illustrating an example of an image to be printed in a past print job. FIG. 7 is a diagram illustrating an example of the adjusted color conversion table D1 used in the past print job. Note that FIG. 6 illustrates an image to be printed in a print job using an adjusted color conversion table A-Icc. FIG. 7 illustrates only the profile related to the color C of the target profiles of the adjusted color conversion table A-Icc.

### Configuration of Color Conversion Table Setter 21a

The color conversion table setter 21a displays a color conversion table setting screen when receiving an instruction to execute a new print job. At this time, the color conversion table setter 21a displays a list of color conversion table use history so that the user can reuse the previously used and adjusted color conversion tables D1 and obtain and as color conversion tables to be used for the new print job.

Specifically, the color conversion table setter 21a reads data of history database 232 stored in the storage 23. Then, the color conversion table setter 21a selectably displays the identification information of each of the plurality of adjusted color conversion tables D1 as a list of the color conversion table use history. At this time, the color conversion table setter 21a also displays type information D1 of the object in the image to which the adjusted color conversion table D2 is applied, summary information D1 of the adjusted color conversion table D3, and the like in the color conversion table use history.

The color conversion table setter 21a displays, for example, a list of the color conversion table use history in a list format. The identification information of each adjusted color conversion table D1 is typically expressed as a character string or a symbol string.

In the color conversion table setting screen illustrated in FIG. 5, the R1 area is an area for displaying “List of color conversion table use history”, and in the R1 area, information on the plurality of adjusted color conversion tables D1 is displayed in a list format. To be more specific, in the R1 area, the following information is displayed for each adjusted color conversion table D1.
R1a: Color conversion table ID (i.e., identification information)
R1b: Color conversion table file name
R1c: File name of application target image
R1d: Type information of the object of application target image
R1e: Summary information of color adjustment content of adjusted color conversion table (target profile)
R1f: Summary information of color adjustment content of adjusted color conversion table (device profile)

In the color conversion table setting screen illustrated in FIG. 5, the R2 area is an area for displaying an image after adjustment when the adjusted color conversion table D1 temporarily selected in the list of the color conversion table use history is applied to the image to be printed this time. Specifically, in one area, an original image before adjustment and an image after adjustment are displayed side by side. Note that the adjusted color conversion table D1 to be temporarily selected in the list of the color conversion table use history can be changed by an operation of moving the position of the cursor Rt2.

In the color conversion table setting screen illustrated in FIG. 5, a R3 area is an operation button for selecting and confirming the adjusted color conversion table D1 to be used in the current print job from the list of the color conversion table use history. Here, the following buttons are displayed in the first area.
R3a: Create New button (here, means a button for newly creating a color conversion table from the reference color conversion table 231.)
R3b: Select <No modification> (here, this means a button for selecting not to make a modification to the adjusted color conversion table D1.)
R3c: Select <Modification> (here, this means a button for correcting the adjusted color conversion table D1)

Note that Rt1 in FIG. 5 is an operation button for changing the provisionally selected adjusted color conversion table D1 from the list of the color conversion table use history. Here, the user can move the cursor Rt2 up or down to change the temporarily selected adjusted color conversion table D1 from the list of the color conversion table use history.

In the color conversion table setting screen, the type information D1 of the object in the image to which each adjusted color conversion table D2 is applied is displayed in the list of the color conversion table use history. That is, as described above, the appropriate color adjustment content by the color conversion table varies depending on the image to be printed (i.e., the type of the object to be subjected to color adjustment). In this respect, the user can grasp the purpose of use and the use application of each adjusted color conversion table D1 from the type information D2 of the object in the image.

That is, the user can select the adjusted color conversion table D1 applied to the object type identical or similar to the object type of the image to be printed of the new print job by browsing the list of the color conversion table use history. As a result, the user can save the trouble of recreating a new color conversion table.

Here, when the “selected” button 21a is pressed, the color conversion table setter R3c displays the input/output curve (see FIG. 7) of the temporarily selected adjusted color conversion table D1, and receives a modification operation of the input/output curve. Then, the color conversion table setter 21a sets the modified color conversion table as a color conversion table to be used in the current print job.

The following images are displayed on the color conversion table modification screen of FIG. 7.
P1: Check box for selecting whether to set a modification target as a target profile or a device profile in the input/output curve of the adjusted color conversion table D1.
P2: Region for displaying the input/output curve (target profile or device profile) of the adjusted color conversion table D1
P3: Check box for selecting an input/output curve (target profile or device profile) of a color (here, any one of four colors of CMYK) to be displayed in P2.
P4: Operation button for fixing the input/output curve of the modified color conversion table

That is, in the display area of P2, an input/output curve that is to be modified (the target profile or the profile) selected in P1 and that has the color selected in P3 is displayed. Then, on the screen P2, a user's touch operation is accepted, and the input/output curve can be changed by the touch operation.

Returning to FIG. 5, the items of the summary information of R1e and the summary information of R1f in the list of the color conversion table use history will be described.

These items R1e and R1f are items for displaying summary information D1 composed of a character string or a symbol string generated to enable the user to easily identify the profile of the input/output curve of the adjusted color conversion table D3.

As can be seen from FIG. 5, it is difficult to display, for each adjusted color conversion table D1, all of the graphs of the adjusted target profiles and the graphs of the adjusted device profiles in the list of color conversion table use history.

Therefore, the color conversion table setter 21a according to the present embodiment displays the items D1 and R1f related to the summary information in which the characteristics of the input/output curve of the adjusted color conversion table R1e are converted into a character string or a symbol string which can be recognized by the user.

Here, the item R1e is summary information related to the target profile, and the item R1f is summary information related to the device profile.

In particular, “C+, M−” in the summary information R1e in FIG. 5 indicates that the color C has been adjusted so as to be added to the target profile in the reference color conversion table 231 and the color M has been adjusted so as to be subtracted from the target profile. Furthermore, “K−” in the summary information R1e in FIG. 5 represents that adjustment has been made so that the K color is subtracted from the target profile in the reference color conversion table 231. Furthermore, “M−” in the summary information Rif in FIG. 5 indicates that the M color has been adjusted so as to be subtracted from the device profile in the reference color conversion table 231.

Note that for example, such summary information D3 is generated by data conversion of the adjusted color conversion table D1 by the history data generator 21b when a new adjusted color conversion table D1 is registered.

In practice, for example, the following operations are performed by the user to set a color conversion table to be used for a new print job.

First, the user searches for the adjusted color conversion table D1 applied to the type of the object matching or similar to the type of the object in the image to be printed from the list of the color conversion table use history in consideration of the printing purpose of the new print job. At this time, the user also refers to the summary information D1 of the adjusted color conversion table D3.

Then, the user presses the cursor operation button Rt1 to move the cursor Rt2 up and down, and temporarily selects a desired adjusted color conversion table D1 from the list of the color conversion table use history. Thus, the original image before adjustment and the image after adjustment are displayed on the color conversion table setting screen. The user browses the adjusted image and considers whether or not the input/output curve of the temporarily selected adjusted color conversion table D1 needs to be modified.

When it is determined that the adjusted color conversion table D1 does not needs to be modified, the user presses the “select <no modification>” button R3b. Then, the user determines the adjusted color conversion table D1 as a color conversion table to be used for a new print job. On the other hand, when determining that the adjusted color conversion table D1 needs to be modified, the user presses a “select <modification>” button R3c. Then, the user modifies the adjusted color conversion table D1 (see FIG. 7). Next, the user determines the modified color conversion table as a color conversion table to be used for a new print job.

### Configuration of History Data Generator 21b

When a print job is executed, the history data generator 21b stores the adjusted color conversion table D1 used in the print job in the storage 23 as the history database 232. That is, the history data generator 21b generates the history data so that the color conversion table setter 21a can display a “list of color conversion table use history” (see FIG. 5) when executing a new print job.

First, the history data generator 21b analyzes an image to be printed in a print job and identifies the type of an object shown in the image. Next, the history data generator 21b stores, in the storage 23, the type information D2 of the object in association with the adjusted color conversion table D1 used in the print job.

At this time, the history data generator 21b identifies the type of the object shown in the image to be printed of the print job, for example, by pattern recognition processing using a known convolutional neural network (CNN). Note that the method of image analysis by the history data generator 21b is arbitrary, and for example, a pattern recognition technique such as a support vector machine (SVM) classifier, a Bayes classifier, or template matching may be used.

Secondly, the history data generator 21b converts the characteristics of the input/output curve of the adjusted color conversion table D1 into summary information D3, and stores the summary information in the storage 23 in association with the adjusted color conversion table. The summary information D3 typically includes a character string or a symbol string that can be recognized by the user.

At this time, the history data generator 21b generates the summary information D3, for example, by representing the color adjusted by the user and the direction in which the adjustment is made in the reference color conversion table 231 by a character string or a symbol string. Furthermore, the history data generator 21b may use a natural language processing technique using AI when generating the summary information D3.

Note that the summary information 21b generated by the history data generator D3 may be summary information of a change from the reference color conversion table 231. Alternatively, the summary information may be summary information of the characteristics of the input/output curve of the adjusted color conversion table D1.

The timing at which the history data generator 21b generates such history data is, for example, after a print job is executed. However, a part of the processing may be a new print job when the color conversion table setter 21a displays the color conversion table setting screen.

### Configuration of Color Adjustment Executer 21c

The color adjustment executer 21c performs color conversion of the print image on the basis of the color conversion table set by the color conversion table setter 21a when printing is executed. Next, the color adjustment executer 21c sends the color-converted image data to the printer 30 via the communicator 26 for actual printing.

Note that the color conversion processing itself by the color adjustment executer 21c is similar to that of a known technology, and therefore, description herein is omitted.

### Operation Flow of Controller 21

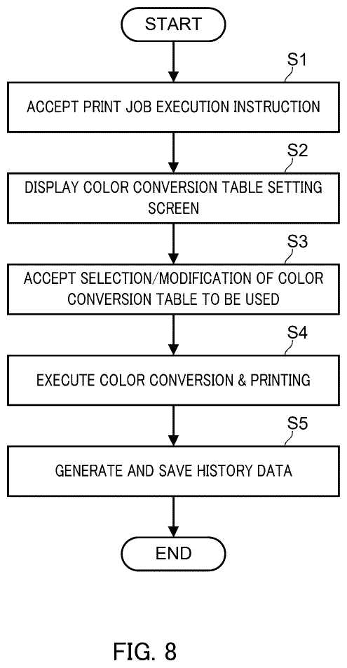

FIG. 8 is a diagram illustrating an example of an operation flow of the controller 21 when a print job is executed.

First, the controller 21 receives the print job execution instructions from and the print instruction terminals 10 and (step S1). Next, the controller 21 displays the color conversion table setting screen illustrated in FIG. 5 on the display 25 in order to accept the setting of the color conversion table to be used in the current print job from the user (step S2). Then, the controller 21 waits for a user operation, and receives selection and/or modification of a target color conversion table to be used in the current print job from the list of the color conversion table use history displayed on the color conversion table setting screen (step S3).

Next, the controller 21 uses the color conversion table selected and/or modified in step S3 to perform the color conversion processing of the image to be printed. Then, the controller 21 transmits the color-converted image to the printer 30 via the communicator 26, and causes the printer 30 to perform actual printing (step S4).

Next, the controller 21 generates history data related to the color conversion processing. Then, the controller 21 stores the history data in the storage 23 in association with the adjusted color conversion table D1 used in the current print job (step S5). As described above, the history information related to the color conversion process is, for example, the adjusted color conversion table D1 used in the print job, the type information D2 of the object shown in the image of the print target, and the summary information D1 of the characteristics of the input/output curve of the adjusted color conversion table D3.

Through such a series of operation flows, the controller 21 ends the print job for which the execution command has been received.

### Effect

As described above, the printing system 100 according to the present embodiment includes the history data generator 21b that stores, when a print job has been executed, an adjusted color conversion table adjusted by a user used in the print job and the type information D2 of an object shown in an image to be printed identified by image analysis in association with each other in a storage 23; and the color conversion table setter 21a that generates a screen for setting a color conversion table to be used in a new print job when executing the new print job, and selectably displays identification information of each of the plurality of adjusted color conversion tables D1 stored in the storage part 23 together with the type information D2 of the object as a list of color conversion table use history on the screen.

According to the printing system 100 of the present embodiment, the user can save the trouble of newly recreating a color conversion table in order to perform color adjustment suitable for an image to be printed for each new print job. In particular, when displaying a list of adjusted color conversion tables D1 used in past print jobs, the printing system 100 according to the present embodiment displays type information D2 of an object shown in an image to which the color conversion table has been applied. Therefore, the user can easily select the color conversion table suitable for the image to be printed in the current print job from the list of the color conversion table use history.

In the present embodiment, the history data generator 21b converts the characteristics of the input/output curve of the adjusted color conversion table D1 into the summary information D3 represented by characters or symbols that can be recognized by the user. Then, the color conversion table setter 21a displays the identification information of each of the plurality of adjusted color conversion tables D1 together with the summary information D3 in the list of the color conversion table use history.

Thus, the user can easily recognize the characteristics of the input/output curve of the adjusted color conversion table D1 from the list of the color conversion table use history. As a result, the user can easily select a color conversion table suitable for the image to be printed in the current print job from the list of the color conversion table use history.

Further, in the according to the present embodiment, the color conversion table setter 21a modifies the input/output curve of the adjusted color conversion table D1 by a user's operation, and enables the modified color conversion table to be used in a new print job.

Thus, the user can easily create a color conversion table suitable for the image to be printed of the current print job based on the adjusted color conversion table D1 used in the past print jobs.

Further, in the according to the present embodiment, the color conversion table setter 21a displays the image after the modification when the adjusted color conversion table D1 temporarily selected in the list of the color conversion table use history is applied to the image of the new print job.

Accordingly, the user can easily grasp the adjustment contents of each of the adjusted color conversion tables D1 used in the past print jobs.

### Modification 1

The present modified example is different from the above-described in that the color conversion table setter 21a further presents candidates of the adjusted color conversion table D1 suitable for use in a new print job from the list of the color conversion table use history.

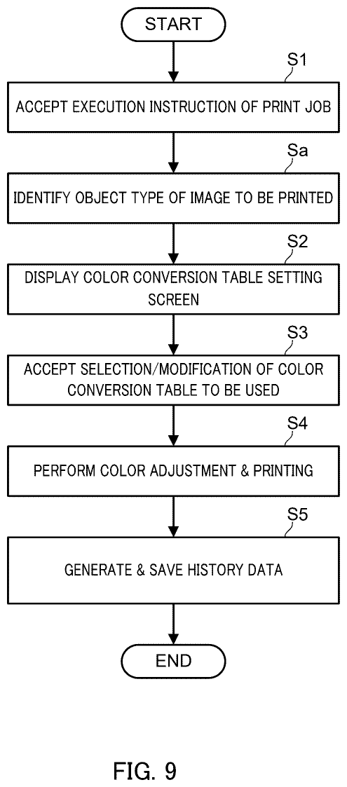

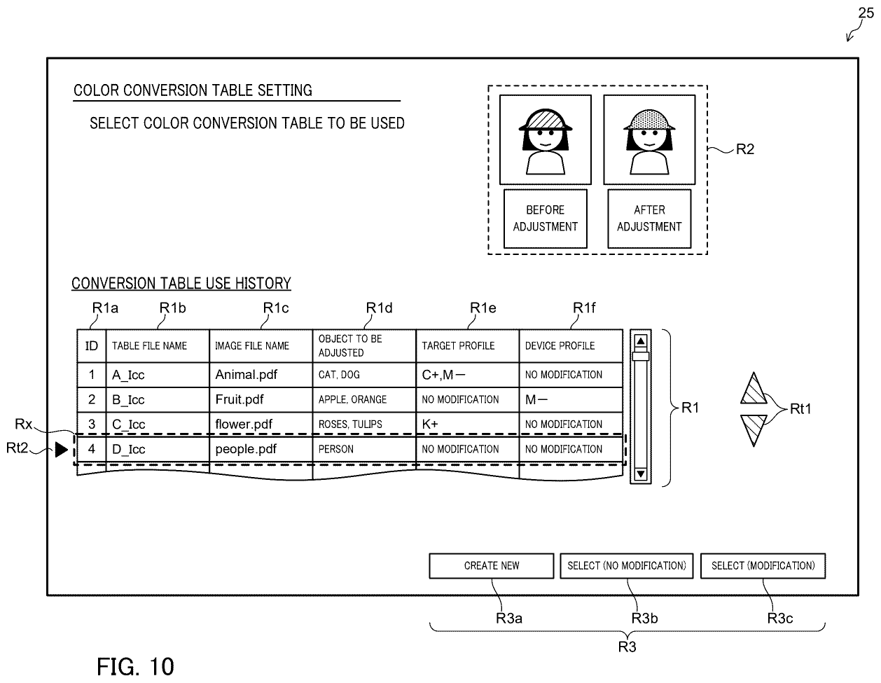

FIG. 9 is a diagram illustrating an operation flow of the controller 21 according to the present modification. FIG. 10 is a diagram illustrating a modification example of the color conversion table setting screen.

The operation flow of FIG. 9 is different from the operation flow of FIG. 8 only in that step Sa is inserted between step S1 and step S2.

Here, step Sa is a step in which the controller 21 performs a process of identifying the object type of the image to be printed. Specifically, in step Sa, the controller 21 first performs image analysis (e.g., pattern recognition processing) of the image to be printed of the current print job to identify the type of an object shown in the image.

Thereafter, the controller 21 displays a color conversion table setting screen on the display 25 (step S2). At this time, the color conversion table setter 21a extracts, from the list of color conversion table use history, a color conversion table whose type matches or is similar to the type of the object shown in the image to be printed of the current print job. Next, the controller 21 presents the color conversion table candidates suitable for the current print job to the user on the color conversion table setting screen.

On the color conversion table setting screen illustrated in FIG. 10, color conversion table candidates suitable for the current print job are displayed with markers Rx attached thereto.

Note that as the method of determining the degree of matching of the types of objects, for example, a method of using text data may be used. Alternatively, a method of expressing the type of each object in a vector format and calculating the similarity between the vectors may be used.

As described above, the color conversion table setter 21a according to Modification Example 1 refers to the type of the object shown in the image to be printed in the new print job and the type information D1 of the object stored in association with the adjusted color conversion table D2. Then, the color conversion table setter 21a presents a candidate of the adjusted color conversion table D1 suitable for the new print job from the list of the color conversion table use history based on them.

Thus, the user can easily select, from the list of color conversion table use history, a color conversion table suitable for the image to be printed of the current print job.

In the printing system 100 according to the first modification, the type information of the object shown in the image to be printed of the current print job may be information input by the user.

### Modification 2

The present modification example is different from the above-described embodiment in that the color conversion table setter 21a further displays an adjusted color conversion table D1 and summary information on adjustment content such as point color adjustment used at the same time in the list of the color conversion table use history.

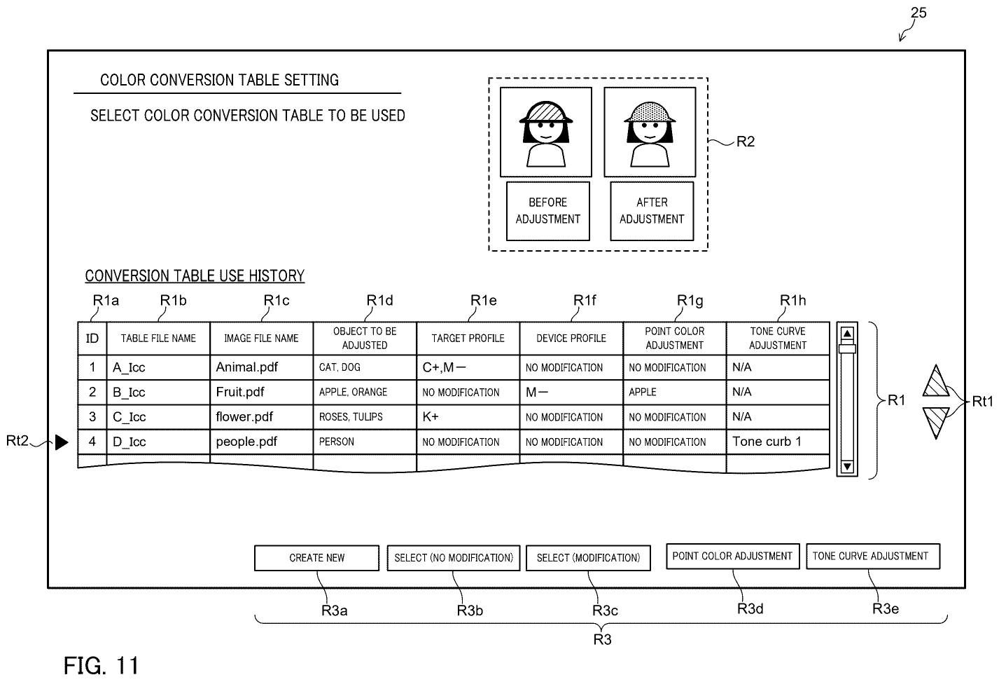

FIG. 11 is a diagram illustrating a color conversion table setting screen according to the present modification.

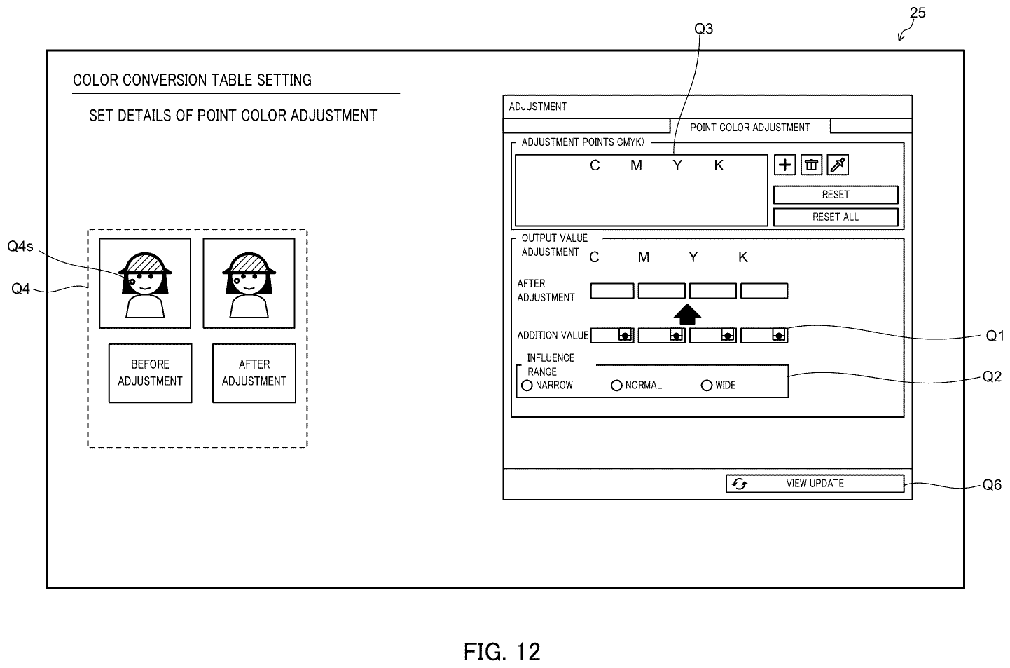

FIG. 12 is a diagram illustrating an example of a setting screen for a point color adjustment function.

This modification example illustrates a case where the point color adjustment or the tone curve adjustment is used in addition to the color adjustment by the color conversion tables and when the color adjustment is performed on the images to be printed and.

Point color adjustment is a function of performing color adjustment on an image to be printed by performing designation by a user operation so that the colors of the particular areas of the image to be printed become particular colors. In the case where the point color adjustment is performed, the color of the designated region of the image becomes the color of the designated color when the color adjustment by the color conversion table is performed.

The point color adjustment is typically used to designate a specific region (for example, the skin of a person) of an object in an image to a specific color. In addition, the point color adjustment can also be used to remove the graininess and the like of the specific regions (e.g., character portions) generated when the color conversion tables are used.

The application target of the point color adjustment is typically an object to which the user pays attention in the print image. Therefore, if the type of the object is displayed in the list of the color conversion table use history, the user can easily select the color conversion table suitable for the image to be printed of the new print job.

From such a viewpoint, the color conversion table setter 21a according to the present modification example displays whether or not the point color adjustment function is used, and point color type information of the object specified when the point color adjustment function is used in the list of the color conversion table use history. When the user selects the adjusted color conversion table D1 as the color conversion table to be used in the current print job, the point color adjustment function of the same condition is set at the same time.

In FIG. 11, in the lists of and color conversion table use history, in addition to the items illustrated in FIG. 5, and items related to the use status related to the point color adjustment function and R1g are displayed. FIG. 11 illustrates, as an example, a mode in which the point color adjustment function is used for the color conversion table ID_3 and the object type of the region designated by the point color adjustment function is “apple”.

Also, In FIG. 11, a modify button R3d for the point color adjustment function and a modify button R3e for the tone curve adjustment function are displayed on the color conversion table setting screen, and these can be modified from the registered content.

Information related to whether or not point adjustment has been performed and the content of the point adjustment is generated by the history data generator 21b. That is, for example, when generating the history data on the color conversion processing, the history data generator 21b identifies the type of object in the area for which the point color adjustment is specified. Next, the history data generator 21b stores, in the storage 23, information on whether or not the point adjustment has been performed, the content of the point color adjustment, and the type of the object in the area for which the point color adjustment has been specified, in association with the adjusted color conversion table D1 that has been used. Note that since an adjustment point is specified in the point color adjustment, the history data generator 21b uses this adjustment point as a reference position to identify, by pattern recognition processing, the type of object in the area for which the point color adjustment is specified.

Thus, the color conversion table setter 21a can display, in the list of the color conversion table use history, whether or not the point adjustment has been performed, and the type of the object in the region designated by the point color adjustment.

The following contents are displayed on the setting screen of the point color adjustment function in FIG. 12.
Q1: Region for inputting CMYK values to be added to adjustment points of point color adjustment
Q2: Region for setting an influence range of the color subjected to point color adjustment on surrounding colors
Q3: Region for displaying CMYK values of adjustment points of point color adjustment
Q4: Region for indicating “image to be adjusted” (an image before adjustment is displayed on the left side and an image before adjustment is displayed on the right side)
Q4s: Target region for point color adjustment (i.e., adjustment points)

The setting screen of FIG. 12 is displayed, for example, when the modification button R3d of the point adjustment function is selected in FIG. 11. On this setting screen, the user can set the contents of point color adjustment to be used together with the color conversion table.

Furthermore, in the present modification example, a form in which the tone curve adjustment function can be used is described, and the tone curve adjustment function is a modification function of adjusting the brightness and contrast of an image.

Further, the color conversion table setter 21a according to the present modification displays, in the list of the color conversion table use history, whether or not the tone curve adjustment function is used, and the tone curve type used in the tone curve adjustment function as.

Here, a plurality of types of tone curves are registered, and the user can select and use a tone curve from the plurality of types of tone curves. Then, when the user selects any of the adjusted color conversion tables D1 as a color conversion table to be used in a new print job, the same type of tone curve adjustment is set at the same time.

In FIG. 11, a R1h area of the list of the color conversion table use history is an area for displaying the “use state related to the tone curve adjustment function”. FIG. 11 illustrates, as an example, a form in which the tone curve adjustment function is used for a color conversion table ID-4 and at that time, “Tone curb 1” is used in the tone curve adjustment function.

Information on whether tone curve adjustment is to be performed and the content of the tone curve adjustment (i.e., type, and of the tone curve) is generated by the history data generator 21b. For example, when generating the history data on the color conversion process, the history data generator 21b stores, in the storage 23, information on whether tone curve adjustment has been performed and on the tone curve type of the tone curve adjustment, in association with the adjusted color conversion table D1 that has been used.

As described above, with the printing system 100 according to the present modification, the user can more easily select a color conversion table suitable for the image to be printed of the current print job from the list of the color conversion table use history.

In addition, even if the point color adjustment feature or tone curve adjustment feature is being used in conjunction with a color conversion table, the user can use these features under the same conditions with the adjusted color conversion table D1. Therefore, according to the printing system 100 of the present modification example, it is possible to more reliably perform the same color adjustment as when the adjusted color conversion table D1 was used in the past on the image to be printed this time.

### Modification 3

The present modified example is different from the above-described in that the color conversion table setter 21a further displays information relating to the usage of the adjusted color conversion table D1 in the list of the color conversion table use history.

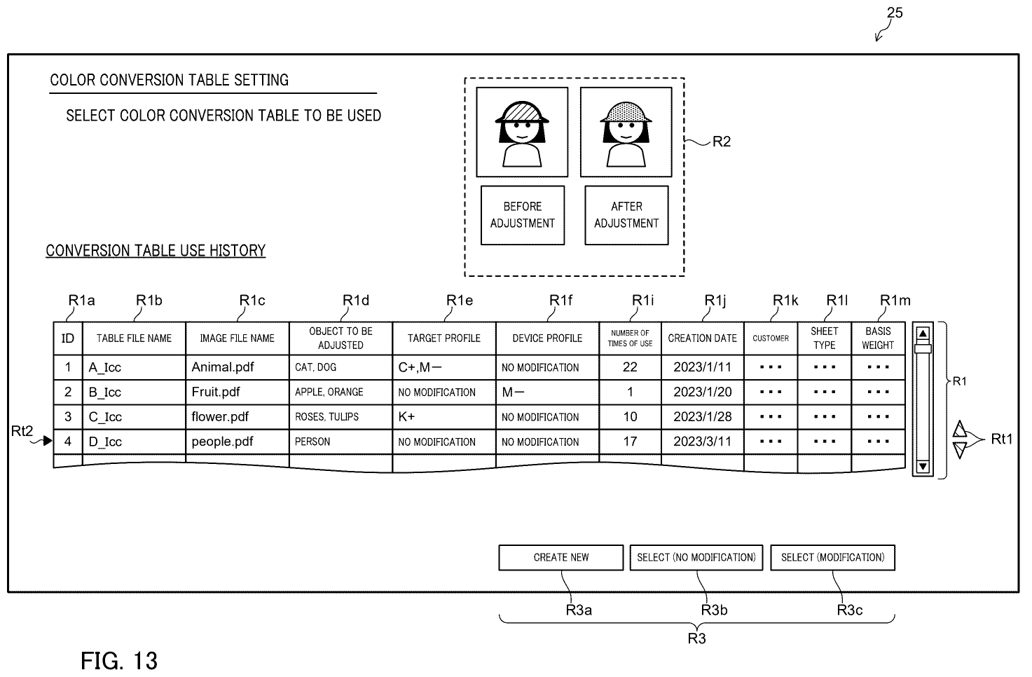

FIG. 13 is a diagram illustrating a color conversion table setting screen according to the present modification.

On the color conversion table setting screen according to the present modification, in the list of the color conversion table use history the following items are displayed in addition to the display item illustrated in FIG. 5.
R1i: “Number of times used” of the adjusted color conversion table D1
R1j: “Creation day” of the adjusted color conversion table D1
R1k: “Customer” using adjusted color conversion table D1
R1l: “Sheet type” used for printing when the adjusted color conversion table D1 is used
R1m: “Basis weight of sheet” used for printing when the adjusted color conversion table D1 is used

That is, in the present modification example, the history data generator 21b is configured to, for example, when generating history data on color conversion processing, count up the number of times of use for the adjusted color conversion table D1 every time it is reused by the user, and store it in the storage 23. Then, the color conversion table setter 21a displays the number of times of use in the list of the color conversion table use history together with the identification information of the adjusted color conversion table D1.

Thus, the user can easily grasp the use frequency of each color conversion table used in the past print job from the list of the color conversion table use history. Then, the user can use the information as reference information when selecting a color conversion table suitable for the image to be printed of the current print job.

Furthermore, in the present modification example, the history data generator 21b is configured to, for example, when generating the history data on the color conversion processing (step S5 in FIG. 8), store the information on the creation date on which the adjusted color conversion table D1 was created and the using customer in the storage 23. Then, the color conversion table setter 21a displays the information related to the creation date and the using customer together with the identification information of the adjusted color conversion table D1 in the list of the color conversion table use history.

Further, In the present modification, the history data generator 21b has a configuration in which, for each of the plurality of adjusted color conversion tables D1, the job setting information relating to the information of the sheet type and the basis weight when the adjusted color conversion table D1 is used is also stored in the storage 23. Then, the color conversion table setter 21a displays the job setting information together with the identification information of the adjusted color conversion table D1 in the list of the color conversion table use history.

The information on the creation date and the using customer of the adjusted color conversion table D1 can be useful reference conditions when identifying the use of the adjusted color conversion table D1. Similarly, job setting information on information on the sheet type and information on the basis weight when the adjusted color conversion table D1 is used can be useful reference conditions when identifying the use of the adjusted color conversion table D1.

As described above, with the printing system 100 according to the present modification example, the user can easily grasp, from the list of color conversion table use history, how each of the color conversion tables used in past print jobs is used. Thus, the information can be used as reference information when the user selects a color conversion table suitable for the image to be printed of the current print job.

### Modification 4

The present modification example is different from the above-described embodiment in that a color conversion table setter 21a enables filtering and/or sorting based on a predetermined item in a list of color conversion table use history of the color conversion table setting screen.

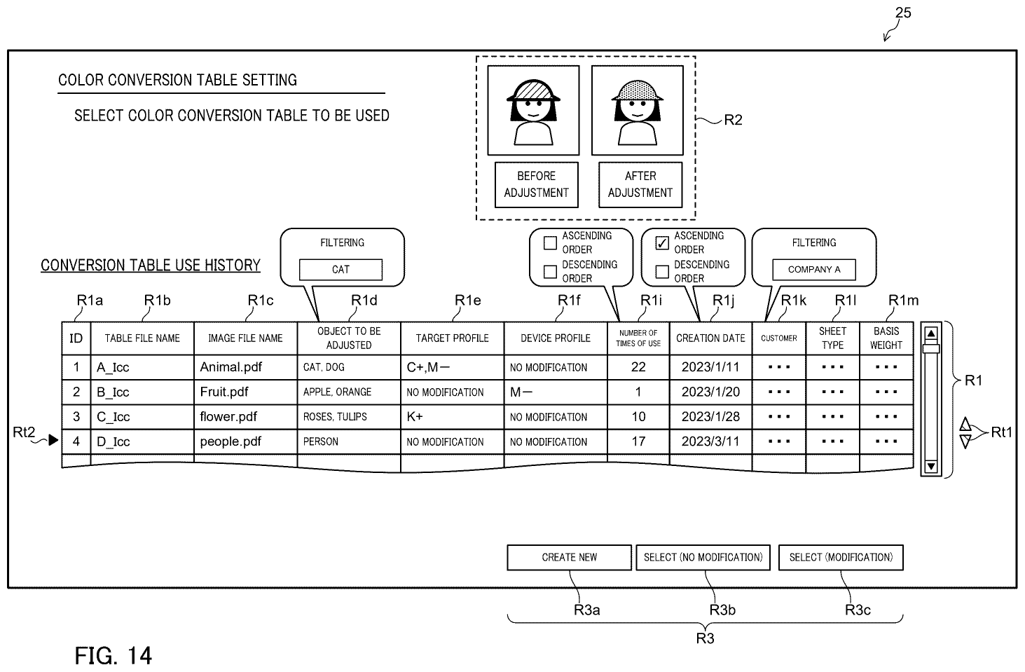

FIG. 14 is a diagram illustrating a color conversion table setting screen according to the present modification.

In FIG. 14, in the list of the color conversion table use history, the item R1d related to the “object to be adjusted” and the item R1k related to the “customer” can be filtered. In addition, in the list of the color conversion table use history, the item D1 related to the “the number of use” of the adjusted color conversion table R1i and the item D1 related to the “creation date” of the adjusted color conversion table R1j can be rearranged in ascending order. Note that the filtering function and the sorting function are typically executed using text information and numerical information of these items stored in the storage 23.

Thus, when selecting a color conversion table suitable for an image to be printed of a new print job, the user can easily search the list of color conversion table use history for a color conversion table that matches desired conditions.

### Modification 5

The present modification is different from the embodiment in that the color conversion table setter 21a can change the setting of an item to be displayed in the list of the color conversion table use history by a user operation.

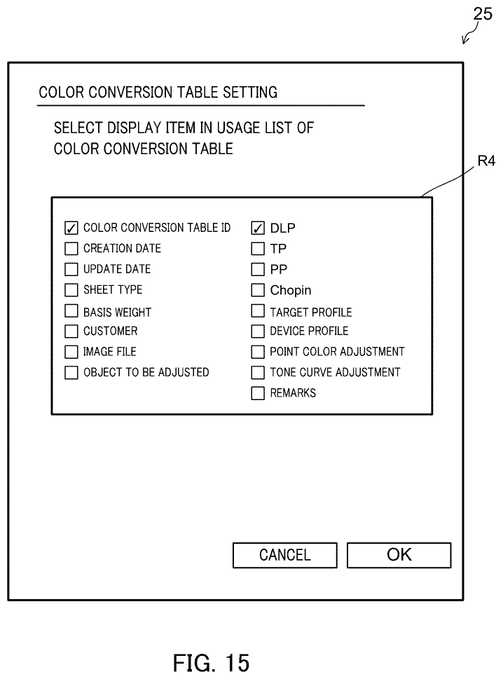

FIG. 15 is a diagram illustrating an example of a screen for setting items to be displayed in the list of the color conversion table use history.

FIG. 15 illustrates a mode in which the UI image R4 with the check box is displayed for each of the plurality of candidate display items on the screen for setting the display item. The user can select a display item to be displayed in the list of the color conversion table use history by turning on/off each of the check boxes.

Thus, it is possible to enhance the viewability of the list of color conversion table use history in the color conversion table setting screen according to the user's preference.

### OTHER EMBODIMENTS

The present invention is not limited to the above-described embodiment, and various modification aspects are conceivable.

For example, when a color conversion table is created, an automatic adjustment function related to solid retention, turbidity removal, or color sample automatic adjustment use may be used. In this case, the color conversion table setter 21a may be configured to display, for each of the plurality of adjusted color conversion tables D1, whether or not the automatic adjustment function is used in the list of the color conversion table use history.

Further, the color conversion table setter 21a may be configured such that, for a predetermined item in the list of the color conversion table use history, the original data associated with the data is displayed in a pop-up form by a touch operation of the user. Such items include, for example, “image file name R1c”, “adjustment content R1e for reference target profile”, and “adjustment content R1f for reference device profile”.

Specifically, for example, when “Animal.pdf (image file name R1c)” is touched, the color conversion table setter 21a may display an image of the original file (see FIG. 6) in a pop-up window. Furthermore, when “C+, M−(target profile R1d)” is touched, the color conversion table setter 21a may pop-up display the target profile (see FIG. 7) in a graph form.

Although embodiments of the present invention have been described and illustrated in detail, the disclosed embodiments are made for purpose of illustration and example only and not limitation. The scope of the present invention should be interpreted by terms of the appended claims.

### INDUSTRIAL APPLICABILITY

According to the printing system of the present disclosure, it is possible to reduce the setting work of the color conversion table.

### REFERENCE SIGNS LIST

10 Print instruction terminal
20 Controller member
21 Controller
21a Color conversion table setter
21b History data generator
21c Color adjustment executer
23 Storage
24 Inputter
25 Display
26 Communicator
27 Bus
30 Printer
100 Printing system
231 Reference color conversion table
232 History database
D1 Adjusted color conversion table
D2 Type information of the object
D3 Summary information

What is claimed is:

1. A printing system comprising a hardware processor,
wherein, when a print job has been executed, the hardware processor stores, in a storage, an adjusted color conversion table adjusted by a user used in the print job, and type information of an object shown in an image to be printed that has been identified by image analysis in association with each other, and
wherein, when executing a new print job, the hardware processor generates a screen for setting a color conversion table to be used in the new print job, and displays, in the screen, identification information of each of a plurality of the adjusted color conversion tables stored in the storage together with the type information of the object in a selectable manner as a list of color conversion table use history.

2. The printing system according to claim 1,
wherein the hardware processor has a function of converting characteristics of an input/output curve of the adjusted color conversion table into summary information represented by a letter or a symbol that is recognizable for the user, and
wherein the hardware processor displays, in the list of the color conversion table use history, the identification information of each of the plurality of adjusted color conversion tables together with the summary information.

3. The printing system according to claim 1, wherein the hardware processor presents a candidate of the adjusted color conversion table suitable for use in the new print job from the list of the color conversion table use history based on a type of the object shown in the image to be printed in the new print job and the type information of the object stored in association with the adjusted color conversion table.

4. The printing system according to claim 1, wherein when a point adjustment function configured to designate a color of a specific area of an image to be printed has been used together with the adjusted color conversion table, the hardware processor displays, in the list of the color conversion table use history, whether the point adjustment function has been used, and the type information of the object related to the specific area specified when the point adjustment function has been used, together with the identification information of the adjusted color conversion table.

5. The printing system according to claim 1, wherein when a tone curve adjustment function configured to adjust brightness of an image to be printed has been used together with the adjusted color conversion table, the hardware processor displays, in the list of the color conversion table use history, whether the tone curve adjustment function has been used, and type information of the tone curve adjustment function, together with the identification information of the adjusted color conversion table.

6. The printing system according to claim 1, wherein the hardware processor allows for modification of an input/output curve of the adjusted color conversion table and setting of the modified adjusted color conversion table as a color conversion table to be used in the new print job by a user's operation.

7. The printing system according to claim 1, wherein the hardware processor displays, in a screen for setting a color conversion table to be used in the new print job, a modified image obtained when the adjusted color conversion table provisionally selected by a user from the list of color conversion table use history is applied to an image to be printed in the new print job.

8. The printing system according to claim 1,
wherein the hardware processor counts up and stores a number of times of use each time the adjusted color conversion table is reused in the new print job for each of the plurality of the adjusted color conversion tables, and
wherein the hardware processor displays the number of times of use of the adjusted color conversion table together with the identification information of the adjusted color conversion table for each of the plurality of adjusted color conversion tables in the list of the color conversion table use history.

9. The printing system according to claim 1, wherein the hardware processor displays a creation date and a using customer of the adjusted color conversion table for each of the plurality of adjusted color conversion tables in the list of the color conversion table use history.

10. The printing system according to claim 1, wherein the hardware processor displays job setting information of a print job for which the adjusted color conversion table has been used, for each of the plurality of adjusted color conversion tables in the list of the color conversion table use history.

11. The printing system according to claim 1, wherein the hardware processor displays the plurality of adjusted color conversion tables in the list of the color conversion table use history in a filterable manner and/or a rearrangeable manner based on a predetermined item.

12. The printing system according to claim 1, wherein the hardware processor allows for a setting change of an item to be displayed in the list of the color conversion table use history by a user's operation.

13. A printing method comprising:
when a print job has been executed, storing, in a storage, an adjusted color conversion table adjusted by a user used in the print job, and type information of an object shown in an image to be printed that has been identified by image analysis in association with each other, and
when executing a new print job, generating a screen for setting a color conversion table to be used in the new print job, and displaying, in the screen, identification information of each of a plurality of the adjusted color conversion tables stored in the storage together with the type information of the object in a selectable manner as a list of color conversion table use history.

14. A non-transitory computer-readable recording medium storing a printing program for causing a computer to execute:
when a print job has been executed, a process of storing, in a storage, an adjusted color conversion table adjusted by a user used in the print job, and type information of an object shown in an image to be printed that has been identified by image analysis in association with each other, and
when executing a new print job, a process of generating a screen for setting a color conversion table to be used in the new print job, and displaying, in the screen, identification information of each of a plurality of the adjusted color conversion tables stored in the storage together with the type information of the object in a selectable manner as a list of color conversion table use history.
